(19) United States
(12) Patent Application Publication
(10) Pub. No.: US 2007/0001039 A1
(43) Pub. Date: Jan. 4, 2007

(54) Comminution mill

(76) Inventor: Joachim Steinbeck, Gorisried (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 11/168,880

(22) Filed: Jun. 29, 2005

(51) Int. Cl. B02C 23/36

(52) U.S. Cl. 241/46.013

(57) ABSTRACT

The invention refers to a comminution mill for comminuting product which has to be comminuted, in particular for crushing food leftovers or other biowaste, comprising a housing, a cutter provided therein, and a drive. The invention is characterised by the fact that in the housing of the comminution mill a pump is provided for removing the comminuted product.

The invention refers to a comminution mill for comminuting product which has to be comminuted, in particular for crushing food leftovers or other biowaste, comprising a housing, a cutter provided therein, and a drive.

### BACKGROUND OF THE INVENTION

Comminution mills, in particular for crushing food leftovers and other biowaste, are known. The graded product is here filled in the known devices from above in the mill. In the mill within the housing a rotating cutter is located which is driven by a drive. In the known comminution mills it is necessary to carry out the comminution in batches, that means after a certain amount of food leftovers or biowaste has been comminuted, the mill must be emptied. However, this is not an advantage for a continuous comminution and, in particular for the following presses and drying installations, as they need a continuous feeding. Because of that the food leftovers, respectively biowaste, emptied in batches are often collected in a container, and from there conveyed via a pump to a further processing, for example a press. The pump here produces enough pressure that the press can also work continuously.

This procedure is very time consuming, and requires in particular machines and installations as additional collecting containers and a pump are needed, for example.

### BRIEF ABSTRACT OF THE INVENTION

The invention comes from the state of the art described before, and has the object to provide a comminution mill for comminuting, respectively crushing, food leftovers or other biowaste which does not have anymore the disadvantages of the state of the art described above, and which makes a continuous comminution of the product which has to be comminuted possible.

In order to solve this problem a comminution mill for comminuting product which has to be comminuted, in particular for crushing food leftovers and other biowaste, is proposed which comprises a housing in which a rotating cutter is provided, and which has a drive, which is characterised by the fact that in the housing of the comminution mill a pump is provided for removing the comminuted product. Already by this measurement the additional technical installation of a construction for collecting and the conveying the comminuted product becomes unnecessary. In particular now a continuous comminution is possible as the pump now sucks off the comminuted food leftovers or biowaste, and can convey them to further utilisation. The construction of the comminution mill according to the invention is, according to that, as follows:

The graded product is filled in the mill from above. In the mill there is a mill plate which is arranged rotatably, and is an integral part of the cutter. Furthermore a mill disc is provided which is stationary, and is also part of the cutter. Below the mill plate cleverly on the bottom surface of the rotating mill plate a pump member is connected, preferably in one piece. Of course, this pump member is arranged in a pump room into which the comminuted product is sucked by the pump.

An advantageous development of the comminution mill according to the invention is therefore characterised by the fact that the pump is formed by a pump room and a turbine wheel in the housing of the comminution mill. By this clever combination of comminution mill with the pump and, in particular, the direct arrangement of the pump room below the cutter it is now provided, according to the invention, that the comminution mill does not only comminute the food leftovers, respectively the biowaste, but they are at the same time removed and pressurised sufficiently so that this sufficient for the installations, respectively apparatus, which process them further so that an additional effort for installation technique, for example collecting container with suitable pump, is not necessary.

According to the invention it is, after another modification of the invention, provided that the pump is formed by a pump room and a turbine wheel in the housing of the comminution mill, and the pump room is located below the cutter in a housing. This is a very clever arrangement as, with a comparatively small effort, the cutter as well as the pump may be realised within a housing.

A part of the cutter is, as described shortly before, according to another embodiment of the invention designed as turbine wheel for the pump, and is arranged rotatably in the pump room.

The cutter is, according to the invention and according to a development, here a mill disc and a mill plate.

Mill disc and mill plate interact for comminuting the product. That means that the product which has to be comminuted falls through the funnel tube on the rotating mill plate which is located in the housing. On the outer rim of the housing a mill disc is arranged which comes into contact with the product through the rotational motion of the mill plate, and comminutes it by interaction with the mill plate.

The mill disc is here, according to a convenient modification of the invention, designed as toothed ring.

It is furthermore preferable if the toothed ring is stationary as stator.

It has furthermore been found to be an advantage if the mill plate carries at least one cutting knife. This increases the comminution effect, and leads to a faster comminuting of the product which has to be comminuted.

According to another modification of the invention the cutting knife/knives is/are arranged on the top side of the mill plate in the assembled position. Technical reversed modifications are actually provided, and also comprised by the invention. Thus it may actually be realised by means of the technique of the installation to arrange the pump, for example, above the cutting plate, and to provide the supply of the product which has to be comminuted from the side. The invention is not restricted to the preferred modification of supplying the food leftovers from above.

The same goes for the next development of the invention according to which the turbine wheel is provided, respectively formed, on the bottom surface of the mill plate. The turbine wheel is designed here as one-piece component with the mill plate. It may be, however, designed also in two pieces, and connected with each other by means of suitable connecting means.

The turbine wheel has at least two wings which provide an optimal pumping effect. At the same time the embodiment of the wings has also the result that the comminuted product is conveyed out optimally, and the pump room is not clogged with the comminuted product.

Between the mill disc and the housing and/or the mill plate, according to a preferred modification of the invention, a gap is provided through which the comminuted product is removed, respectively sucked off, because of the sucking effect of the pump. The gap is here, for example, provided at the exterior rim of the mill disc, and connects the room where the cutter rotates with the pump room. The comminuted product is removed, respectively sucked off, because of the sucking effect of the pump.

It is also preferable if the gap is designed circumferential and guided in the pump room. It is furthermore an advantage if the pump room has an outlet via which the comminuted product is pushed out.

The comminution mill according to the invention has also a funnel tube with a feed opening. This feed opening is designed in such a way that reaching by hand inside the cutter is not possible. This is necessary in order to avoid injuries.

A further improvement for accident protection is a development of the invention according to which a protection device against reaching inside is provided on, respectively above, the funnel tube. This protection device secures absolutely reliably the room for the cutter, and prevents unintended or even intended reaching with a hand inside the comminution mill by the operator. The protection device is here designed plate-like, and has a bottom and a top plate. Preferably the top plate has a smaller diameter.

The comminution mill according to the invention is also characterised by the fact that the top plate has a boring through which by means of a ram or a push pole the product which has to be comminuted can be supplied by pushing. This boring is, of course, dimensioned in such a way that a hand cannot reach inside or through, either.

The top and bottom plate of the protection are, according to another embodiment of the invention, arranged at such a distance to each other that reaching inside up to the cutter is absolutely not possible.

According to the invention it is also provided that the drive is provided for the rotational motion of the cutter as well as for the rotational motion of the turbine wheel of the pump. Of course, also solutions are comprised by the invention where one respective separate drive is provided for pump and cutter. However, the best modification is the one described before with only one drive for the rotational motion of the cutter and the rotational motion of the pump.

### BRIEF DESCRIPTION OF THE DIFFERENT VIEWS OF THE DRAWINGS

The invention is described in the following by means of examples. In the drawings:

FIG. 1 Partial section through an embodiment of the comminution mill according to the invention;

FIG. 2 Enlarged section of the comminution mill without drive and

FIGS. 3a, 3b Detailed views of the mill plate according to the invention.

### DETAILED DESCRIPTION OF THE PREFERRED EMBODIMENT

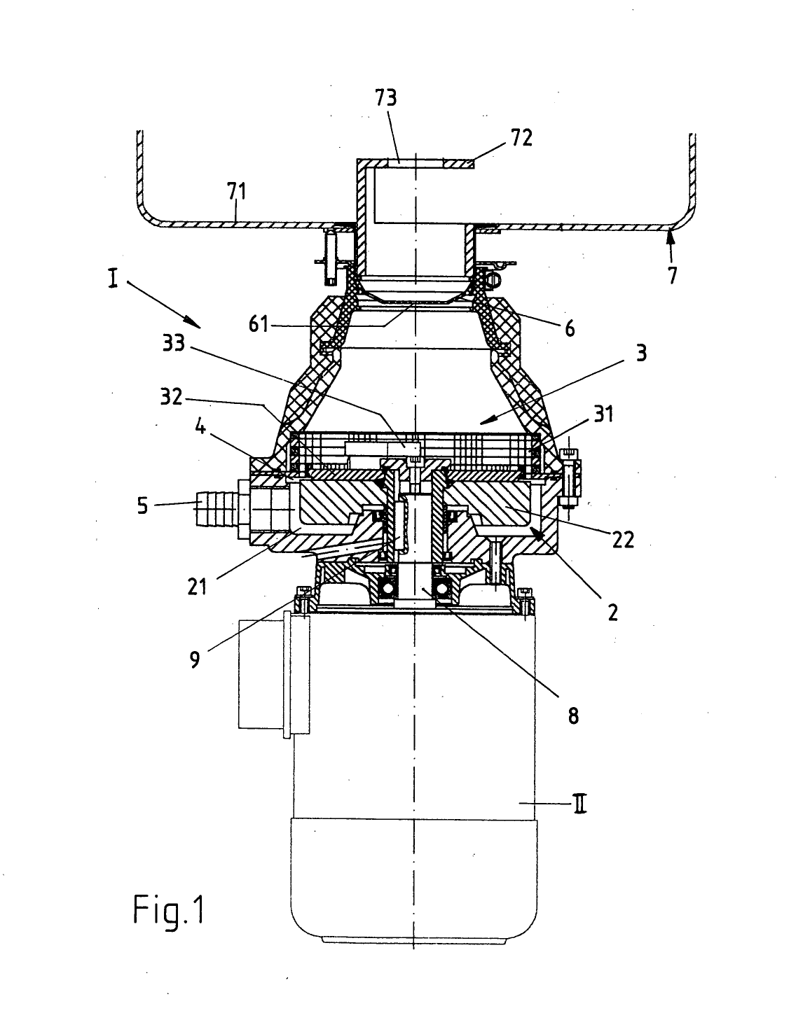

FIG. 1 shows a partial section through an embodiment of the comminution mill I according to the invention. The comminution mill I altogether is indicated schematically by an arrow. The housing 1 encloses the top part of the comminution mill. In the bottom part only the drive II is located which is designed for example as electro-motor. The drive II drives, via a shaft 8, the cutter 3 for the comminution mill I. The cutter 3 is formed here by a mill disc 31 and a mill plate 32. The mill disc 31 is, in the shown embodiment, designed as toothed ring and stationary, while the mill plate 32 is supported rotatably. The mill plate 32 is here driven by the shaft 8. On the bottom surface of the mill plate 32 the turbine wheel 22 is arranged which is also driven via the shaft 8. The turbine wheel 22 itself is located in the pump room 21. The pump 2 again is only indicated schematically, and is formed by the turbine wheel 22 and the pump room 21.

Cleverly, the turbine wheel 22 is located below the mill plate 32, the space between the mill disc 31 and the mill plate 32 being restricted by a gap 4. This gap 4 is circumferential and provides that the comminuted product does not remain in the top part of the comminution mill I, but is sucked off through the gap 4 in the pump room 21, and pushed outside simultaneously by the turbine wheel 22 through the outlet 5. The turbine wheel 22, respectively the pump 2, here produces so much pressure that it is sufficient to convey the comminuted product, for example after that in a centrifugal press for drying the moisturised comminuted product. The produced pressure is sufficient so that no individual pump, respectively no additional pump, is required for supplying the centrifugal press. In this respect the comminution mill according to the invention has, besides the already described effects of a continuous conveying and comminuting, even the additional effect of saving an additional pump which produces the pressure for a centrifugal press arranged after that for drying the moisturised grade product which may be, for example, food leftovers of a canteen, biowaste or the like.

The shaft 8 is connected positive interlocking with the mill plate 32, respectively the turbine wheel 22, via a spring 9, so that a drive without any problems is possible. The mill plate 32 carries preferably at least one cutting knife 33. Of course, the mill plate 32 may also hold two or more cutting knives 33. In the top region of the housing 1 of the comminution mill I a funnel tube 6 is arranged which has a feed opening 61. The feed opening 61 is here already dimensioned in such a way that a hand cannot, for example, reach until the cutter 3. This absolutely necessary in order to avoid injuries because of an intended or unintended reaching inside the cutter. In order to improve the accident protection further, above the funnel tube 6 a protection device 7 against reaching inside is provided comprising a bottom plate 71 and a top plate 72. By means of that it is now absolutely impossible to reach with one's hand until the cutter 3. If clogging occurs, respectively the product which has to be comminuted does not reach the cutter 3 by itself, a ram through a boring 73 of the top plate 72 may cause the product which has to be comminuted to slide further.

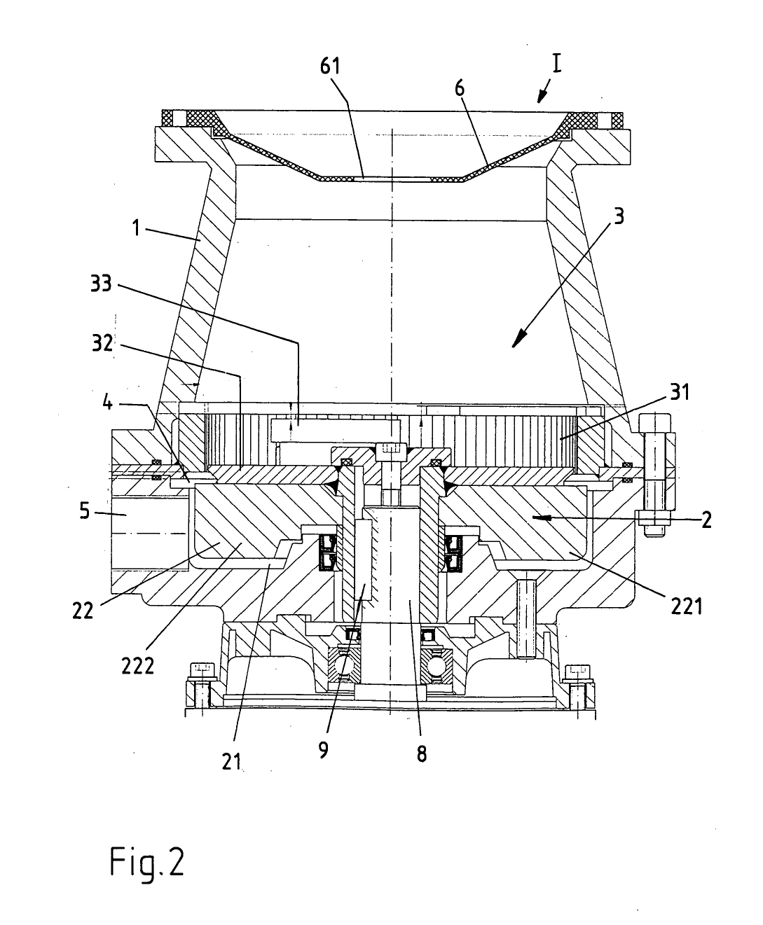

FIG. 2 shows a larger section of the comminution mill I without drive. Only the actual comminution mill with cutter 3 and pump 2 is shown here. The wings of the turbine wheel 22 are indicated by the reference numbers 221 and 222. Preferably the impeller of the comminution mill according to the invention has two turbine wings of this type. All other reference numbers have already been presented in FIG. 1, and are used again in the same way.

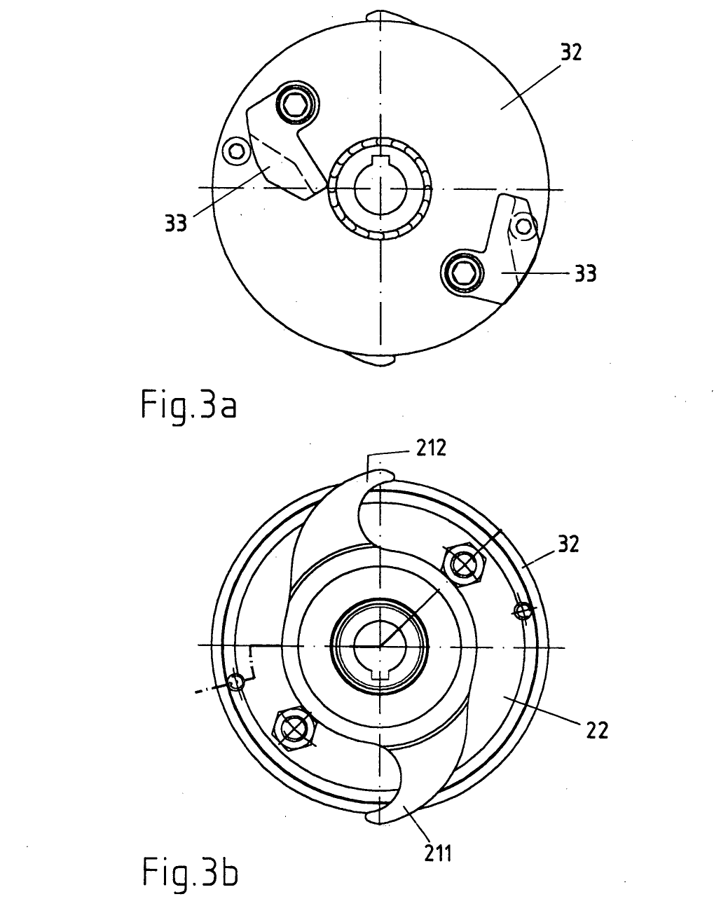

FIGS. 3a and 3b show detail views of the mill plate 32 according to the invention. FIG. 3a shows here the upper surface of the mill plate 32. In the shown embodiment two cutting knives 33 are arranged on the upper surface of the mill plate 32.

FIG. 3b shows the bottom surface of the mill plate for the comminution device according to the invention. The embodiment is here chosen in such a way that the turbine wheel 22 carries two wings 211 and 212.

Although the invention has been described by exact examples which are illustrated in the most extensive detail, it is pointed out that this serves only for illustration, and that the invention is not necessarily limited to it because alternative embodiments and methods become clear for experts in view of the disclosure. Accordingly changes can be considered which can be made without departing from the contents of the described invention.

1. Comminution mill for comminuting a product which has to be comminuted, in particular for crushing food leftovers and other biowaste, comprising a housing, a rotating cutting gear provided therein, and a drive, characterised in that in the housing (1) of the comminution mill (I) a pump (2) is provided for removing the comminuted product.

2. Comminution mill according to claim 1, characterised in that the pump (2) is formed by a pump room (21) and a turbine wheel in the housing (1) of the comminution mill (I).

3. Comminution mill according to claim 1, characterised in that the pump (2) is formed by a pump room (21) and a turbine wheel in the housing (1) of the comminution mill (I), and the pump room (21) is located below the cutter (3) in the housing (1).

4. Comminution mill according to claim 1, characterised in that a part of the cutter (3) is designed as turbine wheel (22) for the pump (2) and is arranged rotatably in the pump room (21).

5. Comminution mill according to claim 1, characterised in that the cutter (3) is provided by a mill disc (31) and a mill plate (32).

6. Comminution mill according to claim 1, characterised in that the cutter (3) is provided by a mill disc (31) and a mill plate (32), and the mill disc (31) interacts with the mill plate (32) for comminuting the product.

7. Comminution mill according to claim 1, characterised in that the cutter (3) is provided by a mill disc (31) and a mill plate (32), and the mill disc (31) is designed as toothed ring.

8. Comminution mill according to claim 1, characterised in that the cutter (3) is provided by a mill disc (31) and a mill plate (32), and the mill disc (31) is designed as toothed ring, and the toothed ring is designed stationary as stator.

9. Comminution mill according to claim 1, characterised in that the cutter (3) is provided by a mill disc (31) and a mill plate (32), and the mill plate (32) carries at least one cutting knife (33).

10. Comminution mill according to claim 1, characterised in that the cutter (3) is provided by a mill disc (31) and a mill plate (32), and the mill plate (32) carries at least one cutting knife (33), and the cutting knives (33) are arranged on the top side of the mill plate (32) in the assembled position.

11. Comminution mill according to claim 1, characterised in that a part of the cutter (3) is designed as turbine wheel (22) for the pump (2) and arranged rotatably in the pump room (21), and the turbine wheel (22) is provided on the bottom side of the mill plate (32).

12. Comminution mill according to claim 1, characterised in that a part of the cutter (3) is designed as turbine wheel (22) for the pump (2) and arranged rotatably in the pump room (21), and the turbine wheel (22) has at least two wings (221, 222).

13. Comminution mill according to claim 1, characterised in that the cutter (3) is provided by a mill disc (31) and a mill plate (32), and between mill disc (31) and housing (1) and/or between the mill plate (32) a gap (4) is provided through which the comminuted product is removed, respectively sucked off, because of the sucking effect of the pump (2).

14. Comminution mill according to claim 2, characterised in that the cutter (3) is provided by a mill disc (31) and a mill plate (32), and between mill disc (31) and housing (1) and/or between the mill plate (32) a gap (4) is provided through which the comminuted product is removed, respectively sucked off, because of the sucking effect of the pump (2), and the gap (4) is designed circumferential and guided in the pump room (21).

15. Comminution mill according to claim 1, characterised in that the pump (2) is formed by a pump room (21) and a turbine wheel in the housing (1) of the comminution mill (I), and the pump room (21) is located below the cutter (3) in the housing (1), and in the pump room (21) an outlet (5) is provided through which the comminuted product is pressed out.

16. Comminution mill according to claim 1, characterised in that a funnel tube (6) with a feed opening (61) is provided.

17. Comminution mill according to claim 1, characterised in that a funnel tube (6) with a feed opening (61) is provided, and on, respectively above, the funnel tube (6) a protection device (7) against reaching inside is provided.

18. Comminution mill according to claim 1, characterised in that a funnel tube (6) with a feed opening (61) is provided, and on, respectively above, the funnel tube (6) a protection device (7) is provided against reaching inside, and the protection (7) is designed plate-like, and has a bottom (71) and a top (72) plate, the top plate (72) having the smaller diameter.

19. Comminution mill according to claim 1, characterised in that a funnel tube (6) with a feed opening (61) is provided, and on, respectively above, the funnel tube (6) a protection device (7) is provided against reaching inside, and the protection (7) is designed plate-like, and has a bottom (71) and a top (72) plate, the top plate (72) having a smaller diameter, and the top plate (72) having a boring (73) through which by means of a ram the product which has to be comminuted can be supplied by pushing.

20. Comminution mill according to claim 1, characterised in that a funnel tube (6) with a feed opening (61) is provided, and on, respectively above, the funnel tube (6) a protection device (7) is provided against reaching inside, and the protection (7) is designed plate-like, and has a bottom (71) and a top (72) plate, the top plate (72) having a smaller diameter, and the top plate (72) and the bottom plate (71) are arranged at such a distance to each other that reaching inside to the cutter (3) is impossible.

21. Comminution mill according to claim 1, characterised in that the pump (2) is formed by a pump room (21) and a turbine wheel in the housing (1) of the comminution mill (I), and the drive (II) is provided for the motion of rotation of the cutter (3) as well as for the turbine wheel (22) of the pump.
